(19) United States
(12) Patent Application Publication
(10) Pub. No.: US 2005/0114875 A1
(43) Pub. Date: May 26, 2005

(54) Disc drive

(76) Inventor: Takashi Sato, Tokyo (JP)

Correspondence Address: PATENTS+TMS;A Professional Corporation, 1914 North Milwaukee Avenue, Chicago, IL, 60647, US

(21) Appl. No.: 10/800,267

(22) Filed: Mar. 12, 2004

(30) Foreign Application Priority Data
Jul. 25, 2003 (JP) 2003-280180

(51) Int. Cl. G11B 33/14

(52) U.S. Cl. 720/648

(57) ABSTRACT

A disc drive at least for reproducing data recorded on an optical disc comprises a main body which includes a base frame having a chassis on which at least an optical pick-up, a turntable and a spindle motor are provided, an outer case made of metallic plates and covering the outside of the base frame, and a front panel provided in front of the outer case and made of a resin material, and a disc tray being movable with respect to the main body between a loaded position at which the optical disc is loaded in the main body and an ejected position at which the optical disc can be placed on or removed from the disc tray. The outer case has a front metallic plate for suppressing or reducing leak of noise generated in the main body due to the rotation of the optical disc to the outside, in which the front plate is provided behind the front panel and each of the front panel and the front plate is formed with a disc tray opening through which the disc tray can move.

### BACKGROUND OF THE INVENTION

1. Field of the Invention

The present invention is related to a disc drive for at least reproducing data recorded on an optical disc.

2. Description of the Prior Art

There are various disc drives which reproduce data from or record and reproduce data to and from optical discs such as a CD-ROM, CD-R, CD-RW, DVD and the like. These disc drives include a box-shaped main body and a disc tray which is movable with respect to such main body, wherein an optical disc is placed on the disc tray and loaded in the main body by moving the disc tray into the main body. A chassis equipped with an optical disc rotating mechanism which includes a turntable and a spindle motor for rotating the turntable is provided inside the main body so that the front end of the chassis can be pivotally moved or displaced in up and down directions within the main body. Further, a disc clamper is provided on the top plate of the main body in a freely rotatable manner (see Japanese Laid-open Utility Model Publication No. 7-41736).

When an optical disc is loaded in the main body, the chassis is pivotally moved or displaced upwardly together with the turntable, whereby the optical disc is placed on the turntable and then held between the disc clamper and the turntable. In this state, the turntable is rotated by the optical disc rotating mechanism, whereby the optical disc is rotated together with the disc clamper.

Now, in this kind of disc drive, when the optical disc is rotated by the optical disc rotating mechanism, vibration is generated by such rotation and the like, and this creates noise.

In general, there is a tendency that more noise leaks out from the front of the main body rather than from the top, sides and bottom of the main body, since the top, sides and bottom of the outer case of the main body are formed from metal plates while the front thereof is only provided with a front panel (front bezel) made of a resin material.

### SUMMARY OF THE INVENTION

It is therefore an object of the present invention to provide a disc drive which can suppress noise and the like generated when an optical disc is rotated by an optical disc rotating mechanism.

In order to achieve the object, the present invention is directed to a disc drive for at least reproducing data recorded on an optical disc. The disc drive comprises a main body which includes a base frame having a chassis on which at least an optical pick-up, a turntable and a spindle motor for rotating the turntable are provided, an outer case made of metallic plates and covering the outside of the base frame, and a front panel provided in front of the outer case and made of a resin material; and a disc tray which is movable with respect to the main body between a loaded position at which the optical disc is loaded in the main body and an ejected position at which the optical disc can be placed on or removed from the disc tray. In this disc drive, the outer case includes top plate, bottom plate, side plates and front plate which respectively cover the top, bottom, sides, front and rear of the base frame, in which the front plate is formed with a disc tray opening and the front panel is also formed with a disc tray opening substantially corresponding to the disc tray opening of the front plate of the outer case so that the disc tray can move through these openings.

According to the disc drive having the above structure, it is possible to suppress or reduce the noise generated in the main body due to the rotation of the optical disc by the provision of the metallic front plate of the outer case.

In the present invention, it is preferred that the front panel comprises a first panel in which the disc tray opening is formed and a second panel which is rotatably provided with respect to the first panel so as to cover the disc tray opening of the first panel.

Further, it is also preferred that the front plate of the outer case further includes at least one opening in addition to the disc tray opening thereof, and the first panel is also formed with an opening substantially corresponding to the opening of the front plate, in which a component or member is provided in the openings so as to close them. According to this structure, the above results can be further improved.

In this case, it is preferred that the component or member includes one selected from the group comprising a headphone terminal for connection with a headphone, a volume control knob for adjusting the reproducing volume level when reproducing data recorded on the optical disc, an emergency ejection hole member through which a jig is adapted to be inserted into the main body to forcedly move the disc tray toward the ejected position at an abnormal state such as power failure, a LED which lights up when the disc drive is operated, and a movement operation button which is operated to move the disc tray when the disc tray is to be moved to the loaded position or the ejected position.

Further, in this case, it is also preferred that the at least one opening of the front plate includes five openings and the front panel also include five openings corresponding to the five openings of the front plate for receiving the headphone terminal, the volume control knob, the emergency ejection hole member, the LED and the movement operation button, respectively.

In the present invention, it is also preferred that the surface area of the front plate excluding the openings formed therein occupies 50% or more of the projected surface area of the front of the disc drive.

Further, it is also preferred that the front plate of the outer case is integrally formed with either one of the top plate or bottom plate.

Another aspect of the present invention is directed to a disc drive for at least reproducing data recorded on an optical disc. The disc drive comprises a main body which includes a base frame having a chassis on which at least an optical pick-up, a turntable and a spindle motor for rotating the turntable are provided, an outer case made of metallic plates and covering the outside of the base frame, and a front panel provided in front of the outer case and made of a resin material; a disc tray which is movable with respect to the main body between a loaded position at which the optical disc is loaded in the main body and an ejected position at which the optical disc can be placed on or removed from the disc tray; and a metallic plate for suppressing or reducing leak of noise generated in the main body due to the rotation of the optical disc to the outside of the main body, the metallic plate is a front plate of the outer case and it is provided behind the front panel, in which each of the front panel and the front plate is formed with a disc tray opening through which the disc tray can move.

The above and other objects, structures and advantages of the present invention will be more apparent when the following detailed description of the embodiment is considered in conjunction with the accompanied drawings.

### BRIEF DESCRIPTION OF THE DRAWINGS

FIG. 1 is a plan view of an embodiment of a disc drive according to the present invention.

FIG. 2 is a plan view showing the internal structure of the disc drive shown in FIG. 1.

FIG. 3 is a cross-sectional side view of the disc drive shown in FIG. 1.

FIG. 4 is an enlarged detailed view of the portion [A] shown in FIG. 3.

FIG. 5 is a front view of an embodiment of the front plate of the disc drive of the present invention.

### DETAILED DESCRIPTION OF THE PREFERRED EMBODIMENTS

The preferred embodiment of the disc drive of the present invention will now be described in detail with reference to the appended drawings.

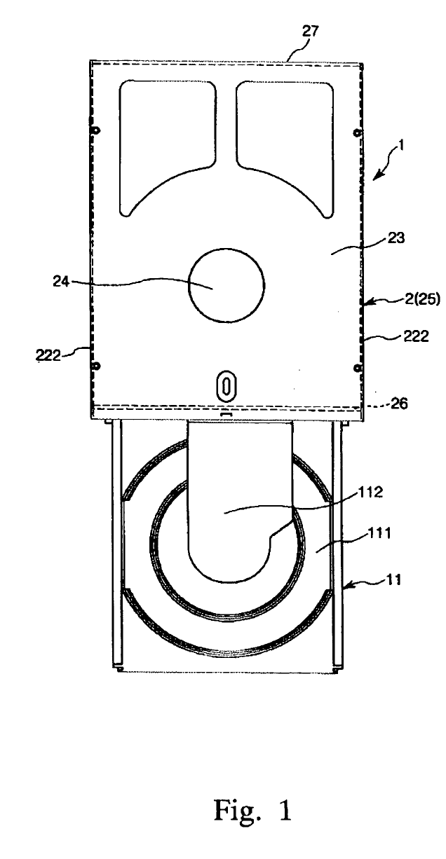

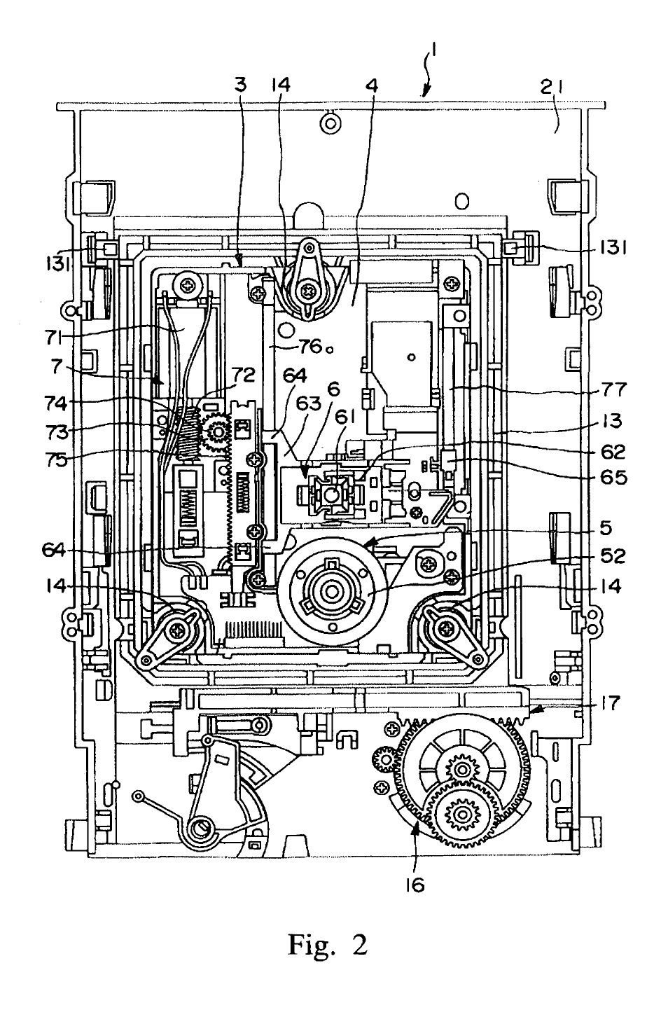

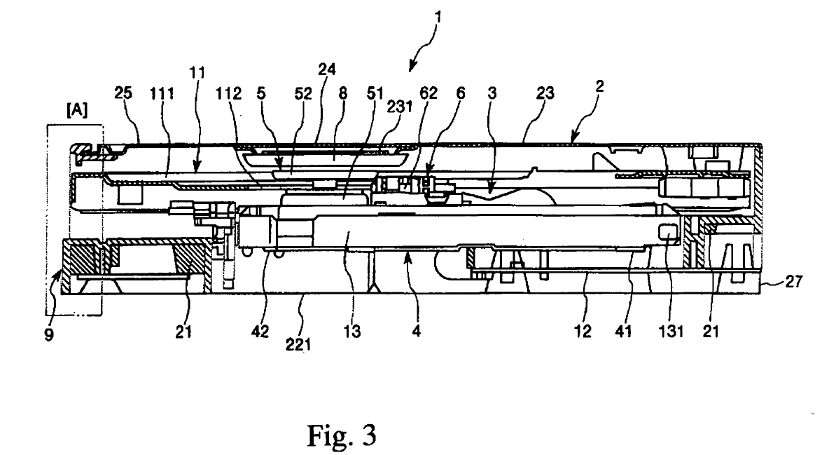

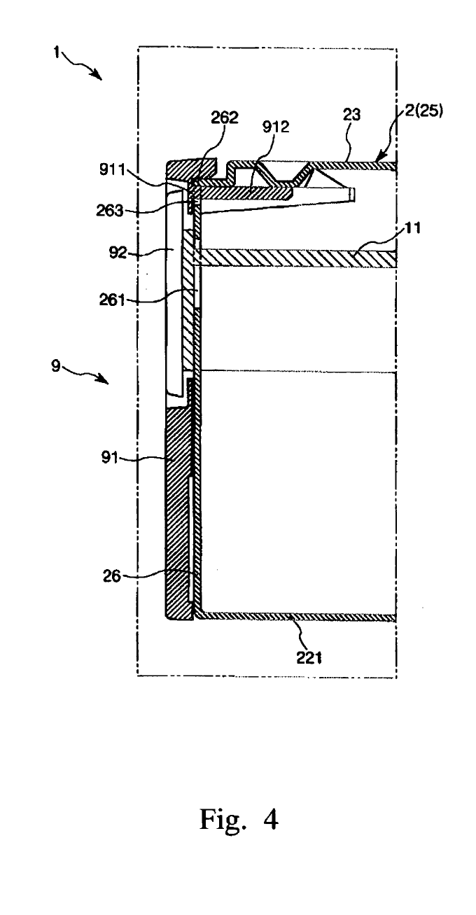

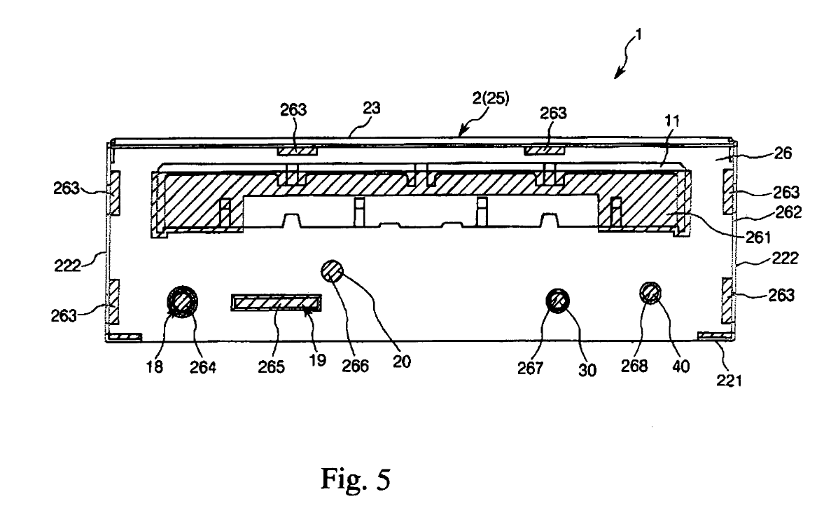

FIG. 1 is a plan view of an embodiment of the disc drive according to the present invention, FIG. 2 is a plan view showing the internal structure of the disc drive shown in FIG. 1, FIG. 3 is a cross-sectional side view of the disc drive shown in FIG. 1, FIG. 4 is an enlarged detailed view of the portion [A] shown in FIG. 3, and FIG. 5 is a front view of an embodiment of the front plate of the disc drive of the present invention. Further, for the sake of convenience, in the following descriptions, unless stated otherwise, the left side in FIG. 3 and FIG. 4 is referred to as the “front”, and the right side as the “back”, and the upper side and the lower side in FIG. 3 through FIG. 5 are referred to as the “top” and the “bottom”, respectively.

A disc drive 1 shown in these drawings has a reproducing (playing back) function (or recording/reproducing function) which reproduces data recorded on an optical disc 200 such as a music CD, CD-ROM, CD-R, CD-RW, DVD or the like, and it is configured so as to be provided in the body of a computer (not shown in the drawings) such as a personal computer, for example.

As shown in these drawings, the disc drive 1 is equipped with a main body 2 which includes an outer case 25, a disc tray 11 on which an optical disc 200 is to be placed and which is movable in the forward and backward directions with respect to the main body 2, and a mechanism unit 3 provided inside the main body 2. A detailed description of the structure of each element is given below.

As shown in FIG. 1 through FIG. 3, the main body 2 includes a base frame 21 and the outer case 25 which covers the base frame 21.

The outer case 25 includes a front plate 26 positioned at the front of the base frame 21, a back plate 27 positioned at the back of the base frame 21, a bottom plate 221 positioned at the bottom of the base frame 21, side plates 222 positioned at the sides of the base frame 21, and a top plate (lid) 23 positioned at the top of the base frame 21.

On the base frame 21, there are provided a disc tray moving mechanism 16, the mechanism unit 3 and a main circuit substrate 12 and the like. The disc tray 11 is also movably supported by the base frame 21.

The outer case 25 having the above structure is fixed to the base frame 21 by machine screws, for example. Further, a space for receiving the disc tray 11 is formed between the base frame 21 and the top plate 23.

In this regard, it is to be noted that both the base frame 21 and the disc tray 11 are formed from a resin material. On the other hand, the members which form the outer case 25 described above are formed from plate-shaped members which have been deformed in a prescribed manner by carrying out press forming or the like on metal plates.

A concave portion 231 is formed by depressing a portion of the top plate 23 which faces the turntable 52. A disc damper 8 is provided in the concave portion 231 in a freely rotatable manner. Further, the outside of the concave portion 231 is preferably covered by a circular plate 24.

The main circuit substrate 12 is formed with a circuit for controlling all operations of the disc drive 1. The main circuit substrate 12 also includes an interface connector for making a connection with the computer, various integrated ICs such as a microprocessor, memories, motor drivers and the like, and various electronic components such as resistors, capacitors, switches and the like. As shown in FIG. 3, the main circuit substrate 12 is provided on the underside of the mechanism unit 3 (chassis 4) described below.

The disc tray 11 has a shallow concave disc holding portion 111, and the optical disc 200 is conveyed in a state where it is placed in the disc holding portion 111.

The disc tray 11 is driven by the disc tray driving mechanism 16 provided on the base frame 21 so as to move (slide) in the forward and backward directions with respect to the main body 2. Namely, the disc tray 11 is movable between a loaded position (the position shown in FIG. 3) at which the optical disc 200 is loaded in the main body 2 (that is, at which the optical disc 200 can be reproduced), and an ejected position (the position shown in FIG. 1) at which the optical disc 200 is ejected (that is, at which the optical disc can be placed on or removed from the disc tray 11). When the disc tray 11 is in the loaded position (hereafter referred to as the “loaded state”), all of the disc tray 11 is housed inside the main body 2. When the disc tray 11 is in the ejected position (hereafter referred to as the “ejected state”), most of the disc tray 11 protrudes out from the main body 2 in the forward direction.

As shown in FIG. 2, a frame member 13 which supports the mechanism unit 3 is provided inside the main body 2. The frame member 13 has a roughly rectangular frame shape. A pair of protruding shafts 131 are respectively formed on both sides of the rear end portion of the frame member 13. Each of the shafts 131 is supported for pivotal movement in each of receiving portions formed in the base frame 21. In this way, the frame member 13 can be pivotally displaced around the shafts 131 with respect to the main body 2 (that is, the base frame 21).

When driven by a driving mechanism 17, the frame member 13 is pivotally displaced between a raised position where the frame member 13 forms a posture roughly parallel with the top plate 23 and the bottom plate 221 in the loaded state (see FIG. 3), and a lowered position where the front end is displaced downward to form an inclined posture with respect to the top plate 23 and the bottom plate 221 in the ejected state.

The mechanism unit 3 is positioned inside the frame member 13. The mechanism unit 3 is mainly constructed from a chassis 4, the optical disc rotating mechanism 5, an optical pickup (optical head) 6 and an optical pickup moving mechanism 7.

The chassis 4 is formed to have a roughly plate shape in which a rib (wall portion) is formed on the edge portions thereof. The disc rotating mechanism 5, the optical pickup 6 and the optical pickup moving mechanism 7 are provided (mounted) on the chassis 4.

The chassis 4 is mounted to the frame member 13 via three rubber bushings (elastic members) 14. These rubber bushings 14 make it possible to absorb vibration and shock.

The optical disc rotating mechanism 5 includes a spindle motor 51 and a turntable 52 fixed to a rotor 511 of the spindle motor 51, and is provided at the front side of the chassis 4. The optical disc rotating mechanism 5 rotationally drives the optical disc 200 loaded (placed) on the turntable 52.

The optical pickup 6 is equipped with an objective lens 61, an actuator 62 which moves the objective lens 61 in the optical axis direction (focusing) and the radial direction (tracking) of the optical disc 200, a laser light source, a light-converging optical system, a beam splitter (or half mirror), a light-receiving element for receiving the reflected light to produce HF signal, focusing signal and tracking signal and the like, and a pick-up base (support member) 63 which supports these elements, wherein the reflected light of the laser light which has been projected to the recording surface of the optical disc 200 is guided to the light-receiving element via the objective lens, the beam splitter (or half mirror) and the like.

In the loaded state, the objective lens 61 is exposed to the disc holding portion 111 and faces the recording surface of the optical disc 200 through an opening 112 formed in the disc tray 11.

The pick-up base 63 is constructed from a metal material manufactured by die casting, for example. The pick-up base 63 is formed with a pair of sliding portions 64 at the left side thereof in FIG. 2. The sliding portions 64 are formed with holes, respectively, through which a guide shaft 76 is inserted. Further, a sliding portion 65 which engages with and slides on a guide shaft 77 is formed on the right side of the support member 63 in FIG. 2.

The optical pickup moving mechanism 7 is generally constructed from a forward/reverse rotatable sled motor 71, a worm 72 fixed to the rotation shaft of the sled motor 71, a large-diameter gear (worm wheel) 73 which meshes with the worm 72, a small-diameter gear 74 which is fixed to the large-diameter gear 73 to rotate on the same shaft, a rack gear 75 which is fixed to the pick-up base 63 to mesh with the small-diameter gear 74, and the pair of guide shafts 76 and 77 which define a moving path of the pick-up base 63 along which the pick-up base 63 is guided.

When the sled motor 71 is driven, the torque thereof is transmitted sequentially to the worm 72, the large-diameter gear 73, the small-diameter gear 74 and the rack gear 75, whereby the pick-up base 13 is moved along the guide shafts 76, 77 in a radial direction of the optical disc 200 within a prescribed moving range. In this case, depending on the rotational direction of the sled motor 71, the pick-up base 63 moves in a direction approaching the center of rotation of the optical disc 200 or in a direction moving away from the center of rotation.

The chassis 4 that is, the mechanism unit 3) can be pivotally moved or rotated with respect to the main body 2 (that is, the base frame 21) together with the frame member 13. As shown in FIG. 3, the shafts 131 function as the center of rotation are positioned near the rear end of the chassis 4. Namely, the rear end of the chassis 4 forms the center of rotation, and therefore forms a rotation end 41 which undergoes almost no displacement with respect to the base frame 21, and the front end of the chassis 4 forms a displacement end 42 which is pivotally displaced roughly in the upward and downward directions with respect to the base frame 21.

In accordance with this structure, when the chassis 4 is in the loaded state (at the raised position), the displacement end 42 is raised to form a posture roughly parallel with the top plate 23 and the bottom plate 221 (see FIG. 3), and when the chassis 4 is in the ejection state (at the lowered position), the displacement end 42 is lowered to form an inclined posture with respect to the top plate 23 and the bottom plate 221. In accordance with the displacement of the displacement end 42 of the chassis 4, the optical disc rotating mechanism 5 also moves between the raised position (the position shown in FIG. 3) and the lowered position inside the main body 2.

When the optical disc rotating mechanism 5 is at the lowered position, the turntable 52 is positioned underneath the disc tray 11 so as not to interfere with the disc tray 11 which is moving toward the ejected position.

When the optical disc rotating mechanism 5 is at the raised position, the turntable 52 is protruded (exposed) to the inside of the disc holding portion 111 through the opening 112, and in this way, the optical disc 200 loaded inside the main body 2 is loaded (placed) on the turntable 52. In this state, the disc damper 8 is attracted to a magnet (not shown in the drawings) provided in the turntable 52, whereby the optical disc 200 is held between the turntable 52 and the disc damper 8.

Now, as shown in FIG. 4 and FIG. 5, in this kind of disc drive 1, a disc tray opening 261 is formed in the front plate 26 at the front of the outer case 25. The disc tray opening 261 is formed to have such size and shape that makes it possible for the disc tray 11 to be inserted or ejected therethrough. In this regard, it is to be noted that the hatched portion in FIG. 5 shows communicating (hole) portions which communicate the inside and the outside of the front plate 26 or cutout (notched) portions 263 formed by cutting out an edge portion 262 of the front plate 26.

The front plate 26 is roughly perpendicular to the bottom plate 221 and is integrally formed with the bottom plate 221 so that the top of the edge portion 262 makes contact with the top plate 23. Further, the front plate 26 is provided so as to cover roughly the entire (total surface) front of the outer case 25 excepting the disc tray opening 261.

The main body 2 includes a front panel (front bezel) 9 provided on the outside of the front plate 26. The front bezel 9 includes a first panel 91 which has substantially the same size and shape as the front plate 26 and covers the front of the front plate 26, and a second panel (lid) 92 which is rotatably provided with respect to the first panel so as to cover the disc tray opening 261. The first panel 91 and the second panel 92 are formed from a resin material.

A plurality (six in the present embodiment) of hooks 912 are formed on a peripheral portion 911 of the first panel 91. By inserting these hooks 912 into the cutout portions 263 of the front plate 26, it is possible to mount the first panel 91 onto the front plate 26. Further, the first panel 91 is formed with openings corresponding to the disc tray opening 261 and other openings of the front plate 26 which will be described later.

In the prior art disc drive, the noise generated when the optical disc 200 is rotated by the optical disc rotating mechanism 5 is transmitted directly through the panel 9 from the portion at the front of the disc drive 1 not covered by the front plate 26, and leaks to the outside of the disc drive 1. On the other hand, in the present embodiment, since the front plate 26 described above is provided, the surface area of the panel 9 through which noise is directly transmitted can be made small, whereby such noise is attenuated, and this makes it possible to remarkably reduce the amount of noise leaking to the outside of the disc drive 1. Namely, it is possible to suppress or reduce leakage of the noise to the outside of the disc drive 1.

Further, as shown in FIG. 5, in addition to the disc tray opening 261, the front plate 26 is formed with a headphone terminal opening 264, an adjustment knob opening 265, an emergency ejection opening 266, a LED opening 276 through which a LED 30, and a movement operation button opening 268, and each of these openings 264, 265, 266, 267, 268 is closed by each of the following components or members.

Namely, in the headphone terminal opening 264, a headphone terminal 18 is provided for connection with a headphone. In the adjustment knob opening 265, a volume control knob 19 is provided for adjusting the reproducing volume level when reproducing data recorded on the optical disc 200. In the emergency ejection opening 266, an emergency ejection hole member 20 is provided (through the hole of the emergency ejection hole member 20, a jig is adapted to be inserted into the main body to forcedly move the disc tray 11 toward the ejected position at an abnormal state such as power failure). In the LED opening 276, a LED 30 which lights up when the disc drive 1 is operated is provided. Further, in the movement operation button opening 268, a movement operation button 40 which is operated to move the disc tray 11 when the disc tray 11 is to be moved to the loaded position or the ejected position is provided.

By closing or covering these openings in the front plate 26 with the components or members as described above, it is possible to further improve the results described above. That is, it is possible to further suppress or reduce leakage of noise to the outside of the disc drive 1.

In this structure, it is preferred that the surface area (i.e., the surface area excluding the hatched portion of FIG. 5) of the front plate 26 occupies 50% or more of the projected surface area of the front of the disc drive 1. Further, the surface area of the front plate 26 is more preferably 60 to 80%. In this way, because the front plate 26 is given a large surface area, it is possible to suppress noise with more reliability. In this regard, in the example shown in the drawings, the surface area of the front plate 26 occupies about 78% of the projected surface area of the front of the disc drive 1.

The disc drive of the present invention was described for the embodiment shown in the drawings, but it should be noted that the present invention is not limited to such embodiment, and it is of course possible to replace each portion constructing the disc drive with any other element exhibiting the same function. Further, it is also possible to add any desired elements.

For example, in the disc drive of the present invention, the front plate is not limited to one which has a headphone terminal opening, a volume control knob opening, an emergency ejection opening, a LED opening and a movement operation button opening as described in the embodiment above. In the present invention, it is sufficient, it the front plate has at least one of these openings.

Further, in the disc drive of the present invention, the front plate is not limited to one which is integrally formed with the bottom plate of the outer case as described in the embodiment above. However, it goes without saying that the front plate may be integrally formed with other plate of the outer case such as the top plate thereof.

1. A disc drive for at least reproducing data recorded on an optical disc, comprising:
a main body which includes a base frame having a chassis on which at least an optical pick-up, a turntable and a spindle motor for rotating the turntable are provided, an outer case made of metallic plates and covering the outside of the base frame, and a front panel provided in front of the outer case and made of a resin material; and
a disc tray which is movable with respect to the main body between a loaded position at which the optical disc is loaded in the main body and an ejected position at which the optical disc can be placed on or removed from the disc tray,
wherein the outer case has at least top plate, bottom plate, side plates, and front plate which respectively cover the top, bottom, sides and front of the base frame, in which the front plate is formed with a disc tray opening and the front panel is also formed with a disc tray opening substantially corresponding to the disc tray opening of the front plate of the outer case so that the disc tray can move through these openings.

2. The disc drive as claimed in claim 1, wherein the front panel comprises a first panel in which the disc tray opening is formed and a second panel which is rotatably provided with respect to the first panel so as to cover the disc tray opening of the first panel.

3. The disc drive as claimed in claim 1, wherein the front plate of the outer case further includes at least one opening in addition to the disc tray opening thereof, and the first panel is also formed with an opening substantially corresponding to the opening of the front plate, in which a component or member is provided in the openings so as to close them.

4. The disc drive as claimed in claim 3, wherein the component or member includes one selected from the group comprising a headphone terminal for connection with a headphone, a volume control knob for adjusting the reproducing volume level when reproducing data recorded on the optical disc, an emergency ejection hole member through which a jig is adapted to be inserted into the main body to forcedly move the disc tray toward the ejected position at an abnormal state such as power failure, a LED which lights up when the disc drive is operated, and a movement operation button which is operated to move the disc tray when the disc tray is to be moved to the loaded position or the ejected position.

5. The disc drive as claimed in claim 4, wherein the at least one opening of the front plate includes five openings and the front panel also include five openings corresponding to the five openings of the front plate for receiving the headphone terminal, the volume control knob, the emergency ejection hole member, the LED and the movement operation button, respectively.

6. The disc drive as claimed in claim 1, wherein the surface area of the front plate excluding the openings formed therein occupies 50% or more of the projected surface area of the front of the disc drive.

7. The disc drive as claimed in claim 1, wherein the front plate of the outer case is integrally formed with either one of the top plate or bottom plate.

8. A disc drive for at least reproducing data recorded on an optical disc, comprising:
a main body which includes a base frame having a chassis on which at least an optical pick-up, a turntable and a spindle motor for rotating the turntable are provided, an outer case made of metallic plates and covering the outside of the base frame, and a front panel provided in front of the outer case and made of a resin material;
a disc tray which is movable with respect to the main body between a loaded position at which the optical disc is loaded in the main body and an ejected position at which the optical disc can be placed on or removed from the disc tray; and
means for suppressing or reducing leak of noise generated in the main body due to the rotation of the optical disc to the outside of the main body, the means comprising a metallic plate provided behind the front panel, in which each of the front panel and the front plate is formed with a disc tray opening through which the disc tray can move.
